(19) United States
(12) Patent Application Publication
(10) Pub. No.: US 2006/0158344 A1
(43) Pub. Date: Jul. 20, 2006

(54) System and method for receiving a wireless status signal in a vehicle from a remote electronic system

(75) Inventors: John S. Bambini, Kentwood, MI (US); Todd R. Witkowski, Zeeland, MI (US)

Correspondence Address: FOLEY & LARDNER LLP, 777 EAST WISCONSIN AVENUE, SUITE 3800, MILWAUKEE, WI, 53202-5308, US

(73) Assignee: Johnson Controls Technology Company, Holland, MI (US)

(21) Appl. No.: 10/531,667

(22) PCT Filed: Oct. 20, 2003
(86) PCT No.: PCT/US03/33252

§ 371 Date: Nov. 7, 2005

Related U.S. Application Data
(60) Provisional application No. 60/419,451, filed on Oct. 18, 2002.

(51) Int. Cl. G05B 23/02; G08C 17/02

(52) U.S. Cl. 340/825.69; 340/5.71; 340/5.61; 340/3.71; 340/3.7; 340/426.15; 340/5.25

(57) ABSTRACT

A wireless control system for wireless control of a remote electronic system comprises a trainable transmitter circuit, a receiver circuit, and a control circuit. The trainable transmitter circuit is configured to transmit a wireless control signal having control data which will control the remote electronic system. The receiver circuit is configured to receive a wireless status signal including status data for the remote electronic system sent in response to the wireless control signal. The control circuit is coupled to the trainable transmitter circuit and the receiver circuit and configured to transmit the wireless control signal through the trainable transmitter circuit and to receive the wireless status signal through the receiver circuit.

### BACKGROUND

In the field of wireless control of remote electronic systems, technological advances have been developed to improve convenience, security, and functionality for the user. One example is a trainable transceiver for use with various remote electronic systems, such as security gates, garage door openers, lights, and security systems. A user trains the trainable transceiver by, for example, transmitting a signal from a remote controller in the vicinity of the trainable transceiver. The trainable transceiver learns the carrier frequency and data code of the signal and stores this code for later retransmission. In this manner, the trainable transceiver can be conveniently mounted within a vehicle interior element (e.g., visor, instrument panel, overhead console, etc.) and can be configured to operate one or more remote electronic systems.

Further advances are needed in the field of wireless control of remote electronic systems, particularly in the case of using automotive electronics to control remote electronic systems. As automotive manufacturers are adding increased electronic systems to the vehicle to improve convenience, comfort, and productivity, simplifying the interface and control of these electronic systems is also becoming increasingly important. In addition, as automotive manufacturers are adding increased electronic systems to the vehicle, providing greater and more refined control over more systems is also becoming increasingly important.

The operator of a trainable transceiver often will activate the trainable transceiver to actuate a remote electronic system as a vehicle is either approaching or leaving the location of the remote electronic system. Often, the operator is not able to immediately ascertain whether the actuation of the device was successful. The actuation can fail based on signal interference, incomplete activation of the trainable transceiver, battery/power failures, etc. Unknown failure of the remote electronic system can cause concern, for example where a garage door fails to close as an operator drives away, leaving the garage open and exposed. Accordingly, an operator is often forced to monitor the remote electronic system to ensure successful operation.

What is needed is an improved wireless control system and method for wireless control of a remote electronic system from a vehicle, wherein the trainable transceiver is configured to receive a feedback signal from a remote electronic system indicating success or failure of a requested operation. Further, what is needed is a system and method of customizing the content of the feedback signal to provide an operator with status information during an operation. Further still, what is needed is a transmitter configured to retransmit a wireless control signal upon receiving a feedback signal indicating a failure.

The teachings hereinbelow extend to those embodiments which fall within the scope of the appended claims, regardless of whether they accomplish one or more of the above-mentioned needs.

### SUMMARY

According to an exemplary embodiment, a wireless control system for wireless control of a remote electronic system comprises a trainable transmitter circuit, a receiver circuit, and a control circuit. The trainable transmitter circuit is configured to transmit a wireless control signal having control data which will control the remote electronic system. The receiver circuit is configured to receive a wireless status signal including status data for the remote electronic system sent in response to the wireless control signal. The control circuit is coupled to the trainable transmitter circuit and the receiver circuit and configured to transmit the wireless control signal through the trainable transmitter circuit and to receive the wireless status signal through the receiver circuit.

According to another exemplary embodiment, a method of receiving status information from a remote electronic system comprises training a trainable transceiver to transmit a wireless control signal, sending a wireless control signal to control the remote electronic system and receiving a wireless status signal from the remote electronic system in response to transmittal of the wireless control signal.

According to yet another exemplary embodiment, a wireless control system comprises a computer coupled to a vehicle interior element, a transmitter and a receiver in communication with the computer, the transmitter being configured to transmit a wireless control signal having control data which will control a garage door opener, the receiver being configured to receive a wireless status signal sent in response to the wireless control signal and including status data for the garage door opener, and a control program operative on the computer. The control program is configured to transmit the wireless control signal and to receive data from the wireless status signal.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1 is a perspective view of a vehicle having a wireless control system, according to an exemplary embodiment;

FIG. 2 is a block diagram of a wireless control system and a remote electronic system, according to an exemplary embodiment;

FIG. 3 is a schematic diagram of a visor having a wireless control system mounted thereto, according to an exemplary embodiment; and

FIG. 4 is a flowchart illustrating a method of training the wireless control system of FIG. 2, according to an exemplary embodiment.

### DETAILED DESCRIPTION OF EXEMPLARY EMBODIMENTS

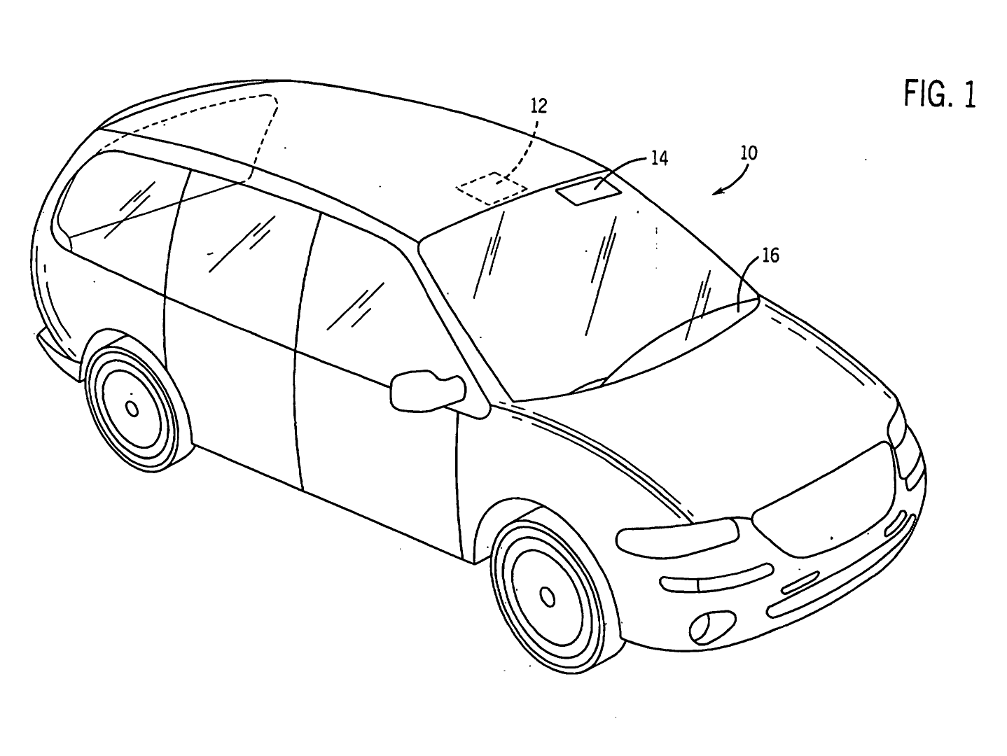

Referring first to FIG. 1, a vehicle 10, which may be an automobile, truck, sport utility vehicle (SUV), mini-van, or other vehicle, includes a wireless control system 12. Wireless control system 12, the exemplary embodiments of which will be described hereinbelow, is illustrated mounted to an overhead console of vehicle 10. Alternatively, one or more of the elements of wireless control system 12 may be mounted to other vehicle interior elements, such as, a visor 14 or instrument panel 16. Alternatively, wireless control system 12 could be mounted to a key chain, keyfob or other handheld device.

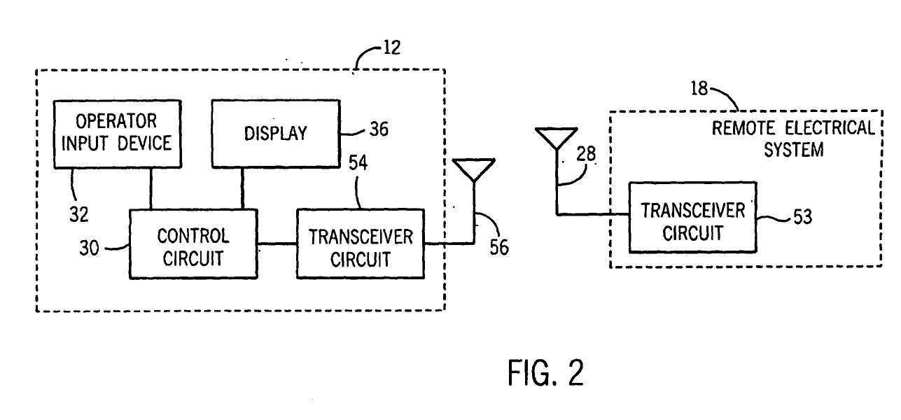

Referring now to FIG. 2, wireless control system 12 is illustrated along with a remote electronic system 18 which may be any of a plurality of remote electronic systems, such as, a garage door opener, a security gate control system, security lights, remote lighting fixtures or appliances, a home security system, etc. For example, remote electronic system 18 may be a garage door opener, such as the Whisper Drive garage door opener, manufactured by the Chamberlain Group, Inc., Elmhurst, Ill. Remote electronic system 18 may also be a lighting control system using the X10 communication standard. Remote electronic system 18 includes a transceiver circuit 53 and an antenna 28.

Transceiver circuit 53 includes transmit and/or receive circuitry configured to communicate via antenna 56 with wireless control system 12. Transceiver circuit 53 is configured to receive wireless control signals having control data which will control remote electronic system 18. For example, the control data can cause a garage door opener to open or close a garage door. Transceiver circuit 53 is further configured to transmit wireless status signals having status data indicating the current status of remote electronic system 18.

The status data on the wireless status signal may include a “SUCCESS” status indicative that the control signal was properly received and the control function was successfully executed by remote electronic system 18. The wireless status signal may be sent upon completion of the function specified in the wireless control signal. The status data may also be an “ACKNOWLEDGE” status indicative that a proper wireless control signal was received by transceiver circuit 53. According to an alternative embodiment, remote electronic system 18 can send a plurality of “IN PROCESS” status signals until completion of the operation whereupon a “SUCCESS” or “FAILURE” status signal may be sent. According to yet more alternative embodiments, the wireless status signal may include other information relevant to remote electronic system 18 for transmittal to wireless control system 12. Examples can include whether a garage door is open or closed or moving between open and closed position, whether a security system is armed or disarmed, whether a light is on or off, etc. The wireless signals are preferably in the ultra-high frequency (UHF) band of the radio frequency spectrum, but may alternatively be infrared signals or other wireless signals.

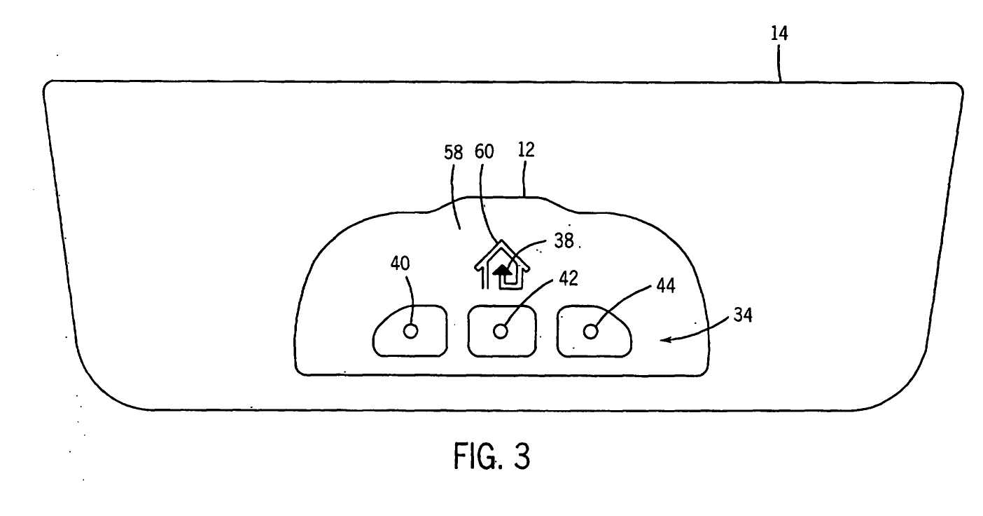

Wireless control system 12 includes a control circuit 30 configured to control the various portions of system 12, to store data in memory, to operate preprogrammed functionality, etc. Control circuit 30 may include various types of control circuitry, digital and/or analog, and may include a microprocessor, microcontroller, application-specific integrated circuit (ASIC), or other circuitry configured to perform various input/output, control, analysis, and other functions to be described herein. Control circuit 30 is coupled to an operator input device 32 which includes one or more push button switches 34 (see FIG. 3), but may alternatively include other user input devices, such as, switches, knobs, dials, a voice-actuated input control circuit configured to receive voice signals from a vehicle occupant, etc. and to provide such signals to control circuit 30 for control of system 12.

Control circuit 30 is further coupled to a display 36 which includes a light-emitting diode (LED), such as, display element 38. Display 36 may alternatively include other display elements, such as a liquid crystal display (LCD), a vacuum florescent display (VFD), or other display elements. Display element 38 can include a single multi-colored LED (e.g., green, red, and yellow) or multiple LEDs, each representing a different color.

Wireless control system 12 further includes a transceiver circuit 54 including transmit and/or receive circuitry configured to communicate via antenna 56 with remote electronic system 18. Transceiver circuit 54 is configured to transmit wireless control signals having control data which will control remote electronic system 18. Transceiver circuit 54 is further configured to receive wireless status signals including status information from remote electronic system 18.

In operation, wireless control system 12 is configured to receive one or more characteristics of an activation signal sent from an original transmitter. An original transmitter is a transmitter, typically a hand-held transmitter, which is sold with remote electronic system 18 or as an after-market item, and which is configured to transmit an activation signal at a predetermined carrier frequency and having control data configured to actuate remote electronic system 18. For example, the original transmitter can be a hand-held garage door opener transmitter configured to transmit a garage door opener signal at a frequency, such as 355 megaHertz (MHz), wherein the activation signal has control data, which can be a fixed code or a cryptographically-encoded code. Remote electronic system 18 is configured to open a garage door, for example, in response to receiving the activation signal from the original transmitter.

Transceiver 54 is configured to receive one or more characteristics of the activation signal from the original transmitter or from another source, which characteristics can include the frequency, control data, modulation scheme, etc. In this embodiment, transceiver 54 is configured to learn at least one characteristic of the activation signal by receiving the activation signal, determining the frequency of the activation signal, and demodulating the control data from the activation signal. Wireless control system 12 can be a Homelink® trainable transceiver, manufactured by Johnson Controls Interiors LLC, Holland, Mich., and may be constructed according to one or more embodiments disclosed in U.S. Pat. No. 6,091,343, 5,854,593 or 5,708,415, which are herein incorporated by reference in their entirety. Alternatively, wireless control system 12 can receive one or more characteristics of the activation signal by other methods of learning. For example, the one or more characteristics of the activation signal can be preprogrammed into memory during manufacture of wireless control system 12 or can be input via operator input device 32 (which can include a key pad, buttons, etc.). In this manner, wireless control system 12 need not actually receive the activation signal in order to receive characteristics of the activation signal. Wireless control system 12 can receive the characteristics of the signal by any of these methods and store the characteristics of the activation signal in memory.

Transceiver circuit 54 is configured, under control from control circuit 30, to generate a carrier frequency at any of a number of frequencies in the ultra-high frequency range, preferably between 20 and 470 megaHertz (MHz), more specifically between 280 and 430 MHz, wherein the control data modulated on to the carrier frequency signal may be frequency shift key (FSK) or amplitude shift key (ASK) modulated, or may use another modulation technique. The control data on the wireless control signal may be a fixed code or a rolling code or other cryptographically encoded control code suitable for use with remote electronic system 18.

Referring now to FIG. 3, an exemplary wireless control system 12 is illustrated coupled to a vehicle interior element, namely a visor 14. Visor 14 is of conventional construction, employing a substantially flat, durable interior surrounded by a cushioned or leather exterior. Wireless control system 12 is mounted to visor 14 by fasteners, such as, snap fasteners, barbs, screws, bosses, etc. and includes a molded plastic body 58 having three push button switches disposed therein. Each of the switches includes a respective back-lit icon 40, 42, 44. Body 58 further includes a logo 60 inscribed in or printed on body 58 and having a display element 30 disposed therewith. During training and during operation, display element 38 is selectively lit by control circuit 30 (FIG. 2) to communicate certain information to the user, such as, whether a wireless status signal indicates “SUCCESS” or “FAILURE”, whether the control system 12 is transmitting a wireless control signal, etc. The embodiment shown in FIG. 3 is merely exemplary, and alternative embodiments may take a variety of shapes and sizes, and have a variety of different elements.

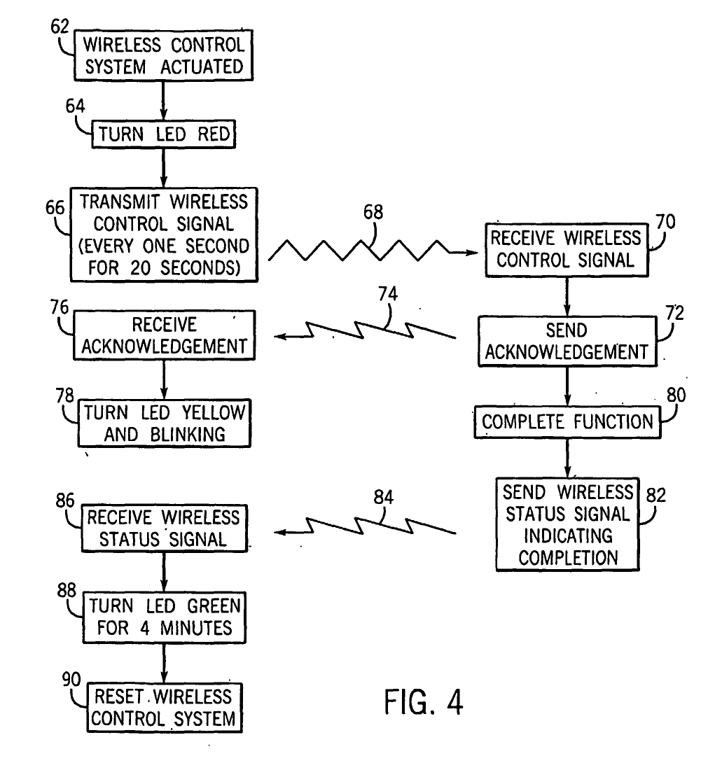

In operation, wireless control system 12 is configured for wireless control of remote electronic system 18. Wireless control system 12 is configured to monitor the status of the control operation and to communicate that status to a user of wireless control system 12. For example, wireless control system 12 can be configured to transmit a wireless control signal from a vehicle to a garage door opener, as will now be described with reference to FIG. 4.

Referring now to FIG. 4, an exemplary method of receiving a wireless status signal from a remote electronic system in response to transmittal of a wireless control signal will now be described. It is understood that one or more of the steps in this exemplary method may be eliminated or rearranged in various embodiments. At step 62, wireless control system 12 is actuated. According to an exemplary embodiment, described above with reference to FIG. 3, actuation of wireless control system 12 can include depression of a push button switch (e.g., as part of operator input device 32) disposed on a wireless control system 12 attached to a vehicle interior element. According to alternative embodiments, actuation can include depression of a button on a handheld wireless transmitter, such as a keyfob, use of a voice command, or any other user input to actuate wireless control system 12.

According to yet another embodiment, actuation can be automated. For example, in a wireless control system 12 including a navigation input device, wireless control system 12 can be configured to transmit the wireless control signal whenever the transmitter is within a predetermined distance to or from the location of the remote electronic system 18. Other examples of automation can include sending the signal based upon timing information, based on time of day information, or any other event-driven transmittal of the wireless control signal.

At step 64, control circuit 30 can turn display element 38 (e.g., an LED) associated with wireless control system 12 red to indicate to the user that wireless control system 12 has been actuated. Alternative embodiments can include different feedback to the user dependent on the feedback capability associated with wireless control system 12. For example, where wireless control system 12 includes a display capable of displaying alphanumeric characters, the display can include a message such as “SIGNAL SENT”. At step 66, control circuit 20 can transmit a wireless control signal 68 using transceiver circuit 54. The control circuit 30 will then be placed in a “listening” or receiving mode where control circuit 30 is monitoring transceiver 54 to receive an acknowledgement signal from remote electronic system 18. Where an acknowledgment signal is not received within a specified time, such as one second, control circuit 30 can be configured to retransmit the signal without requiring another actuation of operator input device 32. Periodically retransmitting wireless control signal 68 will help the system to correct for temporary interference or lack of signal strength in some cases. Control circuit 30 can be configured to retransmit the wireless control signal for a specified number of iterations until receipt by remote electronic system 18 is acknowledged. If the number of iterations exceeds a specified number, the control circuit can communicate a failure to the user of the system by, for example, flashing the red LED.

At step 70, wireless control signal 68 transmitted in step 66 is received by remote electronic system 18 through transceiver circuit 53. Upon receipt, remote electronic system 18 can perform a verification step. Where the signal is valid, remote electronic system 18 can transmit a wireless status signal 74 (e.g., an acknowledgement signal 74) in a step 72 using transceiver circuit 53.

In a step 76, wireless control system 12 can receive acknowledgement signal 74. At a step 78, wireless control system 12 can indicate acknowledgement of the wireless control signal to the user of wireless control system 12 by turning the red LED yellow and blinking. Upon receiving the acknowledgement signal, wireless control system 12 can be placed in a second listening mode where control circuit 30 is monitoring transceiver 54 to receive a wireless status signal. The second listening mode can include a timing limit where control circuit 30 will indicate an error condition if the wireless status signal is not received within a predetermined time limit. If the wireless status signal is not received within the predetermined time limit, control circuit 30 can use display 36 to indicate a failure condition. According to alternative embodiments, alternative types of feedback can be used to indicate that the wireless control signal was received and acknowledged by remote electronic system 18 or that a failure condition has occurred.

After sending the acknowledgement signal in step 72, remote electronic system 18 can perform the function designated by wireless control signal 68 in a step 80. For example, where remote electronic system 18 is a garage door opener, remote electronic system 18 can open or close the garage door in response to receipt of wireless control signal 68. According to alternative embodiments, wireless control signal 68 can include more robust control over remote electronic system 18. Using the garage door opener example, wireless control signal 68 can include an up-only control signal. An up only signal will only activate the garage door opener if the garage door is not already up. If the garage door is up, remote electronic system 18 can be configured to do nothing.

Following completion of the function in step 80, remote electronic system 18 can be configured to transmit a wireless status signal 84 in a step 82. Wireless status signal 84 can be a message indicating that remote electronic system 18 attempted to perform the function. Where the remote electronic system 18 has the capability to verify the success of an operation, remote electronic system 18 can await completion of the operation and then send wireless status signal 84 including information regarding the success or failure of the function or even reasons for failure of the operation. Exemplary information can include garage door closed, garage door open, garage door operation failed, garage door operation failed because of obstruction, etc.

In a step 86, wireless control system 12 can receive and interpret wireless status signal 84. Where wireless status signal 84 indicates success, wireless control system 12 can turn the display element LED green for a period to indicate success in a step 88. Following step 88, wireless control system 12 can reset in a step 90.

According to alternative embodiments, feedback to the user of wireless control system 12 can take a variety of different forms including different levels of content. For example, where wireless control system 12 includes an LCD display screen, the display screen can be used to display a message indicative of the status information received from remote electronic system 18. For example, wherein remote electronic system 12 is a garage door opener, the LCD screen can display “Garage Door Close Signal Sent”, “Garage Door Closing”, “Garage Door Closed”, and/or “Garage Door Closing Error” in response to actuation of wireless control system 12. According to an alternative embodiment, feedback to the driver of the vehicle can include audible feedback to the user of wireless control system 12.

Advantageously, providing a wireless status signal to a user allows the user to have security in knowing whether the intended operation was a success. For example, where a driver pushes a button to close a garage door, the driver does not have to wait until the garage door is closed before driving away. The wireless control system 12 will indicate if any problem has occurred. This feature also increases security, as some drivers will drive away without having verified that the garage door has fully closed. Where the operation fails, the garage door will remain open for the duration until the driver returns. This system will alert the drivers that there has been a failure so that they can correct the problem.

What is claimed is:

1. A wireless control system for wireless control of a remote electronic system, comprising:
a trainable transmitter circuit configured to transmit a wireless control signal having control data which will control the remote electronic system;
an receiver circuit configured to receive a wireless status signal including status data for the remote electronic system sent in response to the wireless control signal; and
a control circuit coupled to the trainable transmitter circuit and the receiver circuit configured to transmit the wireless control signal through the trainable transmitter circuit and to receive the wireless status signal through the receiver circuit.

2. The wireless control system of claim 1, further comprising a vehicle interior element coupled to the transmitter circuit and the control circuit, wherein the wireless control system is configured for mounting in a vehicle interior.

3. The wireless control system of claim 2, wherein the vehicle interior element is an overhead console, a visor, or an instrument panel.

4. The wireless control system of claim 1, wherein the control circuit is configured to enter a listening mode after transmitting the wireless control signal to receive the wireless status signal.

5. The wireless control system of claim 4, wherein the control circuit is configured to retransmit the wireless control signal if the wireless status signal has not be received within a specified time after entering the listening mode.

6. The wireless control system of claim 1, wherein the receiver circuit is further configured to receive a wireless signal, wherein the control circuit is configured to identify and store a data code on the wireless signal, and wherein the wireless control signal transmitted by the trainable transmitter circuit includes the stored data code.

7. The wireless control system of claim 1, wherein the wireless control system further includes a display configured to display an indicia based on the contents of the wireless status signal.

8. The wireless control system of claim 7, wherein the display is a light emitting diode.

9. The wireless control system of claim 8, wherein the light emitting diode is configured to display different colors based on the contents of the wireless status signal.

10. The wireless control system of claim 1, wherein the remote electronic system is a garage door opener.

11. The wireless control system of claim 10, wherein the wireless status signal is an indication that a garage door has successfully closed.

12. A method of receiving status information from a remote electronic system, comprising:
training a trainable transceiver to transmit a wireless control signal;
sending the wireless control signal to control the remote electronic system; and
receiving a wireless status signal from the remote electronic system in response to the transmittal of the wireless control signal.

13. The method of claim 12, wherein sending a wireless control signal includes actuating the trainable transceiver configured to transmit the wireless control signal.

14. The method of claim 12, further including displaying an indicia representative of the contents of the wireless status signal.

15. The method of claim 14, wherein displaying an indicia includes actuating a light emitting diode.

16. The method of claim 12, further comprising training the trainable transceiver by receiving a wireless signal having a data code and identifying and storing the data code on the wireless signal, whereby the wireless control system can wirelessly control the remote electronic system by transmitting the data code of the wireless signal.

17. A wireless control system, comprising:
a computer coupled to a vehicle interior element;
a transmitter and receiver in communication with the computer, the transmitter being configured to transmit a wireless control signal having control data which will control a garage door opener, the receiver being configured to receive a wireless status signal in response to the wireless control signal and including status data for the garage door opener; and
a control program operative on the computer, the control program configured to transmit the wireless control signal and to receive data from the wireless status signal.

18. The wireless control system of claim 17, wherein the wireless status signal is an indication that a garage door has successfully closed.

19. The wireless control system of claim 17, wherein the vehicle interior element is an overhead console, a visor, or an instrument panel.

20. The wireless control system of claim 17, wherein the control program is configured to enter a listening mode after transmitting the wireless control signal to receive the wireless status signal.

21. The wireless control system of claim 20, wherein the control program is configured to retransmit the wireless control signal if the wireless status signal has not be received within a specified time.

22. The wireless control system of claim 17, wherein the receiver is configured to receive a wireless signal, wherein the control program is configured to identify and store a data code on the wireless signal, wherein the wireless control signal transmitted by the transmitter includes the stored data code.

23. The wireless control system of claim 17, wherein the computer further includes a display configured to display an indicia based on the contents of the wireless status signal.

24. The wireless control system of claim 23, wherein the display is a liquid crystal display.

25. The wireless control system of claim 24, wherein the liquid display is configured to display an alphanumeric message based on the content of the wireless status signal.

26. The wireless control system of claim 25, wherein the wireless status signal is an indication that a garage door has successfully closed.
